(19) United States
(12) Patent Application Publication
(10) Pub. No.: US 2010/0164261 A1
(43) Pub. Date: Jul. 1, 2010

(54) SAFETY DEVICE FOR A SEAT

(76) Inventors: Rolf Wich, Hainburg (DE); Uwe Fleckenstein, Linsengericht (DE); Alexander Wüstendörfer, Paunzhausen (DE); Peter Herwig, Aschaffenburg (DE)

Correspondence Address: MAGNA INTERNATIONAL, INC., 337 MAGNA DRIVE, AURORA, ON, L4G-7K1, CA

(21) Appl. No.: 12/377,042

(22) PCT Filed: Aug. 10, 2007
(86) PCT No.: PCT/DE07/01426

§ 371 Date: Feb. 10, 2009

(30) Foreign Application Priority Data
Aug. 10, 2006 (DE) 10 2006 037 655.2
Dec. 18, 2006 (DE) 10 2006 060 177.7

(51) Int. Cl. B60N 2/42; B60N 2/427; C06D 5/00; B60N 2/48

(52) U.S. Cl. 297/216.12; 297/216.1; 102/530

(57) ABSTRACT

In order to design a safety device (51) for a seat (42) for a vehicle, in particular motor vehicle, with an at least partially flexible seat surface (1) and with a barrier means (2) which is to be arranged essentially under the seat surface (1) and is to be erected, in particular in the event of an accident, to prevent an occupant from being displaced forwards in the direction of inertia (3), such that the occupant is securely held in the seat even in the event of an accident, it is proposed that the barrier means (2) is held in the erected state (4) by means of a holding means which is held essentially in a manner such that it does not move back out of a final state corresponding to the erected state (4) of the barrier means (2) without an additional application of force, wherein the holding means is, in particular, a self-locking means (5) and/or a ramp means (43) Which can be latched in place.

The invention relates to a safety device for a seat for a vehicle, in particular a motor vehicle, having an at least partially flexible seat surface, having a barrier means which is to be arranged essentially under the seat surface and is to be placed in an upright position in order to prevent forward displacement of a vehicle occupant in the direction of inertia, in particular in the event of an accident, and to a use of a self-locking means as claimed in claim 30, and to a method for activating a barrier means as claimed in claim 31.

DE 3631881 discloses a vehicle seat having a barrier means which can be placed in an upright position and a seat belt system.

A disadvantage of the known system according to the prior art is that it exerts an inadequate restraining effect on the vehicle occupant. The system has a soft structure and the diversion of force into the seat is insufficient. The system is not suitable for the rear rows of seats in a motor vehicle because of the large possible forward displacement of the vehicle occupants.

The object of the present invention is to permit a vehicle occupant to be held securely in his seat even in the event of an accident.

The object is achieved by means of a safety device as mentioned in the introduction, wherein the barrier means is held in the upright state by means of a holding means which is held, essentially without an additional force effect, to prevent a backward movement out of an end state of the holding means which corresponds to the upright state of the barrier means, wherein the holding means is, in particular, a self-locking means and/or a ramp means which can be latched in place, and wherein, after the barrier means has been placed in an upright position, the barrier means is to be reset, in particular by means of the holding means, after a time period which is sufficient to have restrained the vehicle occupant in order to prevent forward displacement.

The means of achieving the object provides a simple vehicle occupant protection system for means of locomotion, in particular for motor vehicles, for virtually any speed range, which vehicle occupant protection system at the same time ensures that the vehicle occupant is held in his seat in a reliable and a very stable fashion. The invention ensures improved prevention of the forward displacement of the vehicle occupants after a head-on accident by virtue of positive engagement between the barrier means and the seat leg on the pelvis, in particular also with simultaneous tautening of the two seat belt points on the seat. In addition, the resetting of the barrier means, in particular by means by resetting the holding means after a certain time period, in particular if a seat belt system is missing or has not been put on, ensures that a vehicle occupant experiences no possibly undesired displacement in a z-axis direction.

The resetting of the barrier means after a certain short period can also comprise resetting a barrier means in a different way and for an arrangement which is held by a means other than a holding means, wherein according to the invention this is preferably to be performed within the advantageous time period after the placing of the barrier means in an upright position.

The barrier means can be held mechanically by the holding means, in particular self-locking means, with the result that the system comes to rest without force effect and cannot be moved by a comparable force being applied by the vehicle occupant or by the effect of an accident. The self-locking means ensures that the vehicle occupant is held in his seat in a reliable and very stable fashion without having to use further securing means. Owing to the holding function, in particular the self-locking, the direction of movement of the drive cannot be reversed by the vehicle occupant's weight. Installation is, in particular, also possible for sitting places with reduced space for forward displacement since the forward displacement is greatly reduced by the proposed invention.

It is advantageous if the time period is between approximately 30 ms and approximately 70 ms, and is in particular approximately 50 ms. This ensures that the vehicle occupant is not lifted up too high with respect to the seat surface, in which case he could, for example, impact against a roof surface.

It is advantageous if in order to reset the barrier means the holding means is to be lowered at least partially into a recess which is arranged underneath the holding means and in particular is not to be opened until the holding means has been placed an upright position. This permits the lowering process to be carried out in a particularly fast and safe way.

It is advantageous if the holding means is in particular held in a pivotable position on a foot and is to be pivoted down at least partially into the recess by means of a rotation about the pivoting axis.

It is advantageous if the self-locking means has a wedge face with a predetermined angle and/or a wedge face with an at least partially concave and/or convex shape by means of which the barrier means can be placed in the upright position and/or the ramp means has a ramp region and a holding region and is to be held in the end state by means of a latching means. The wedge face and/or the holding region of the ramp means ensure/ensures a secure and mechanically stable hold, with the result that the barrier means can reliably be. placed in an upright position.

The overall height can easily be reduced if the wedge face of the self-locking means is designed in such a way that it can be at least partially folded down, in particular in the upper region. If the wedge face dips down below the surface of the barrier system, a reduced rest height of the barrier system is obtained accompanied at the same time by constant stability.

The wedge face folds up reliably if in the folded down region the wedge face can be folded up essentially as far as an end state, essentially before and/or during the placing of the barrier means in an upright position against the wedge face, said folding up being carried out in particular by means of a raising means, in particular by displacement of the wedge face in relation to a raising face.

Reproducible contact with good transmission of force is provided if the barrier means engages with the wedge face of the self-locking means in a frictionally locking and/or positively locking fashion and/or is held in the holding region of the ramp means by means of at least one contact element by means of which the barrier means is to be folded up.

Particularly rapid and directionally stable activation is possible if the self-locking means is to be activated by displacing the wedge face of the self-locking means, in particular by means of linear displacement in the direction of inertia and/or the ramp means is to be activated by means of displacement, in particular linear displacement, of the ramp region until an end position of the contact element in the holding region is reached. The contact element is, for example, made to roll over the wedge face by the activation of the self-locking means and as a result at the same time the barrier means which is connected to the contact element rotates.

Activation which is adapted to the sensing of an accident occurs if the wedge face is displaced by at least one drive means, which is fast compared to the speed of forward displacement of the vehicle occupant, by exerting a thrust force and/or tractive force.

It is advantageous if the barrier means is embodied in two parts and is arranged on each side of the holding means, in particular of the self-locking means and/or of the ramp means, wherein a width of the barrier means is, in particular, less than the width of the pelvis and in particular greater than a distance between the pelvic bones.

Different reaction variants or action variants for dealing with a current or imminent accident are possible if one drive means is of reversible design and/or one drive means is of irreversible design. The invention can be operated simultaneously with one or else with a plurality of drive means here. The reversible drive means is configured for multiple activation and can also be switched on in the run up to an accident, for example during an anticipatory sensing process. However, if it was possible to prevent the accident, the drive means can be deactivated again easily. If the drive means is configured to be irreversible, the focus of the function of the drive means is placed on a rapid reaction, as a result of which the system is activated within fractions of seconds after an accident has been sensed.

A very rapid reaction with good transmission of force occurs if the drive means has a pyrotechnic unit and/or a unit with gas triggering. After activation, if necessary the pyrotechnic unit can be replaced and the gas charge can be refilled.

A reliable, reversible drive means is obtained if the drive means has a gear wheel which is driven by an energy accumulator, in particular a torque accumulator, in particular a helical spring. The gear wheel then preferably engages in a toothed rail which is attached to the self-locking unit, and said gear wheel displaces the self-locking unit when activation occurs.

It is advantageous if the barrier means is to be activated essentially simultaneously with activation of a restraint system, in particular a seat belt pretensioner in a seat belt lock and/or a seat belt end fitting, in particular on the seat backrest, and/or essentially simultaneously with activation of a neck support system, wherein in particular the activation of the neck support system is to be performed by releasing a neck support in the direction of the vehicle occupant's neck. In this way, a plurality of functions are carried out simultaneously when a drive means is activated. This leads to an accelerated and very well coordinated reaction. The combination with a restraint system has the result that the vehicle occupant is not only held by the barrier means but also pulled even more strongly into the seat by the restrain system, so that the effect of the barrier means is further amplified. The systems can also be activated in reverse and are pre-crash enabled. The invention provides, in addition to the holding by the barrier system, a fully capable restraint system with improved vehicle occupant kinematics for the purpose of synchronizing the overall system.

Force can be passed on safely and quickly if the restraint system and/or the neck support system are/is connected to the holding means, in particular the self-locking means, via, in particular, at least one respectively separate force transmitting means, wherein when the holding means, in particular the self-locking means, is activated, force is simultaneously also to be applied to the restraint system and/or the neck support system.

It is advantageous if in each case a force transmitting means in the form of at least one encased cable means is arranged in the restraint system in such a way that it runs from the holding means, in particular the self-locking means, to the seat belt lock or seat belt end fitting via a deflecting bracket, wherein tensile forces have to be diverted from the cable means to the casing means which is arranged around the cable means and is supported on the deflecting seat belt, with the result that at least one cable means section is held essentially free of force between the holding means, in particular the self-locking means, and the deflecting bracket. The freedom from force relieves the loading on the cable means and the holding means, in particular the self-locking means, and the system operates reliably for longer.

A compact and easily installable embodiment is obtained if the drive means is embodied in one piece with the holding means, in particular the self-locking means.

It is advantageous if the, in particular, reversible drive means can be activated in an actively preventive fashion before an accident. As a result, the active safety of the system is increased without parts of the system having to be additionally replaced after activation occurs.

A reaction time which is optimized for most accidents occurs if the drive means is to be triggered approximately 250 ms before a possible accident.

It is advantageous if, in particular, irreversible drive means can be activated passively in reaction to a request for action, in particular after an accident has been sensed.

It is advantageous if the barrier means is equipped with a warning function, in particular in the event of the vehicle leaving the lane, wherein the warning function is embodied, in particular, as a vibrator system which is installed, in particular, on the contact element in order to move the barrier means.

Safe reactivation of the drive means in order to displace a supporting means is possible a change in pressure is to be brought about in a pressure space inside a supporting means for the wedge face by activating a drive means in order to displace the supporting means, in particular by means of a reversible drive, in particular with an energy accumulator, in particular with a gear wheel which is driven by a torque accumulator, wherein the pressure space is to be ventilated to bring about pressure equalization by means of a valve, in particular a nonreturn valve with a ball on which a spring acts.

An advantageous combination of reversible and active triggering of the activation of the barrier system is obtained if a unit with gas triggering, in particular a micro gas generator, is provided as the drive means, and a reversible drive, in particular with an energy accumulator, in particular with a gear wheel which is driven by a torque accumulator, with the result that at first the barrier means can be positioned by the gear wheel drive in a slow, cautious fashion, wherein the valve ventilates the pressure space in order to bring about pressure equalization, and then, in particular if an accident is actually detected in the same time period, the unit with gas triggering is to be additionally fired, with the result that the positioning of the barrier means is to be accelerated, wherein the pressure space which is activated by the unit with gas triggering is closed off, in order to bring about a rapid increase in pressure by the valve, in particular by the nonreturn valve with a ball on which a spring acts.

An embodiment which is of simple design and is at the same time reliable is obtained if the valve is arranged at a head end of the pressure space.

It is advantageous if in an active position the valve closes off the pressure space, and in an inactive position it permits air to pass through.

An embodiment is particularly low in maintenance and reliable if the valve has a spring-loaded ball which, when there is an increase in pressure, closes off the pressure space, and, when there is a decrease in pressure, is placed, by means of the spring, in the position which permits air to pass through.

The object is also achieved by a seat having an at least partially flexible seat surface with a safety device as claimed in one claims 1 to 28.

The object is also achieved by the use of a holding means which is held, essentially without an additional force effect, to prevent a backward movement out of an end state which corresponds to the upright state of a barrier means, said holding means being in particular a self-locking means for securing the barrier means in contact with a seat surface in a seat of a vehicle in the upright state, which seat surface is to be placed in an upright position in order to prevent forward displacement of a vehicle occupant in the direction of inertia, in particular in the event of an accident, and wherein, after the barrier means has been placed in the upright position, the barrier means is reset, in particular by means of the holding means, after a time period which is sufficient to have restrained the vehicle occupant in order to prevent forward displacement.

The object is also achieved by a method for activating a barrier means in contact with a seat surface in a seat of a vehicle, which barrier means is placed in an upright position in order to prevent forward displacement of a vehicle occupant in the direction of inertia, in particular in the event of an accident, wherein the barrier means is placed in an upright position by displacement of a holding means, in particular a self-locking means, and held by said means, essentially without an additional force effect, in order to prevent a backward movement out of an end state which corresponds to the upright state of the barrier means, and wherein, after the barrier means has been placed in the upright position, the barrier means is reset, in particular by means of the holding means, after a time period which is sufficient to have restrained the vehicle occupant to prevent a forward displacement.

The resetting prevents, in particular, the vehicle occupant experiencing any undesired displacement in the z axis direction.

The object is likewise achieved by means of a valve having a spring-loaded ball which, in an active position, closes off a pressure space and, in an inactive position, permits air to pass through, in particular for a safety device as claimed in one of claims 1 to 28 and/or for a seat as claimed in claim 29 and/or a use as claimed in claim 30, in particular for a method as claimed in one of claims 31 to 34. The valve can be activated and reactivated reliably and with low maintenance.

The object is likewise achieved by means of a wedge face having a straight and/or at least partially convex and/or at least partially concave shape which is designed in such a way that it can be at least partially folded down, wherein the upper part is preferably designed in such a way that it can be folded down in order to reduce the end height in an inactive state, in particular for a safety device as claimed in one of claims 1 to 28, and/or for a seat as claimed in claim 29, and/or a use as claimed in claim 30, in particular for a method as claimed in one of claims 31 to 34. The reduction in the overall height can also be used in other applications with a self-locking means.

Further features and advantages of the invention emerge from the claims and the following description in which exemplary embodiments of the subject matter of the invention are explained in more detail in conjunction with the drawings. The statements in the following embodiments are not to be understood as restrictive but only by way of example. In particular, the devices can also be used within the sense of the invention if the resetting of the barrier means does not take place within a short period after the placing in an upright position but rather only several minutes or a longer period of time later. It is also possible, for example, to use a different holding means according to the invention such as, for example, a ramp means, in the figures described below.

In the drawings:

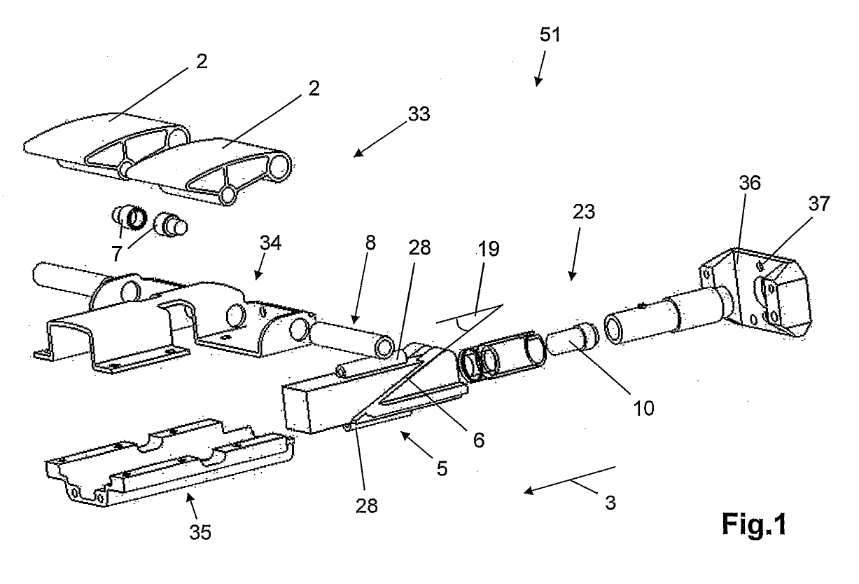

FIG. 1 shows a barrier system having barrier means and self-locking means in an exploded illustration,

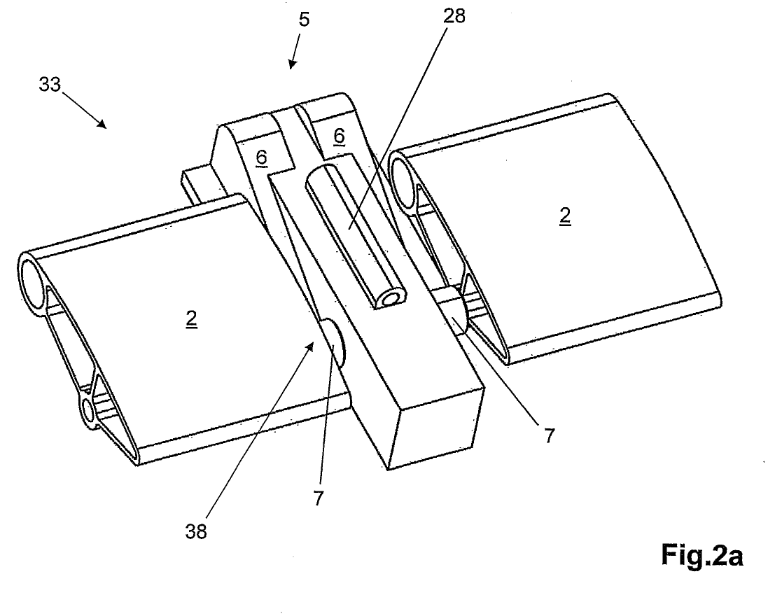

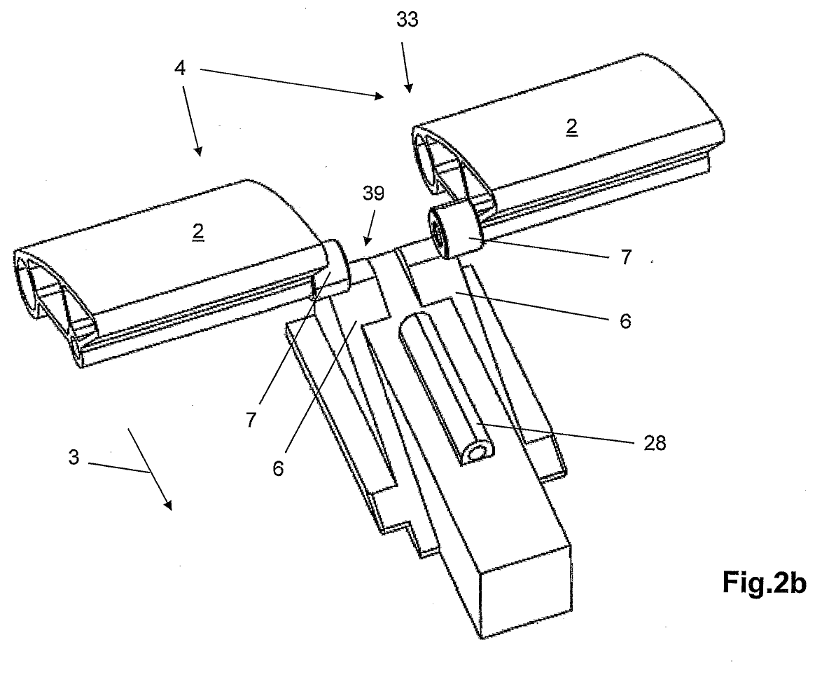

FIG. 2a shows a barrier system having a barrier means and self-locking means in the deactivated state,

FIG. 2b shows a barrier system having barrier means and self-locking means in the activated state,

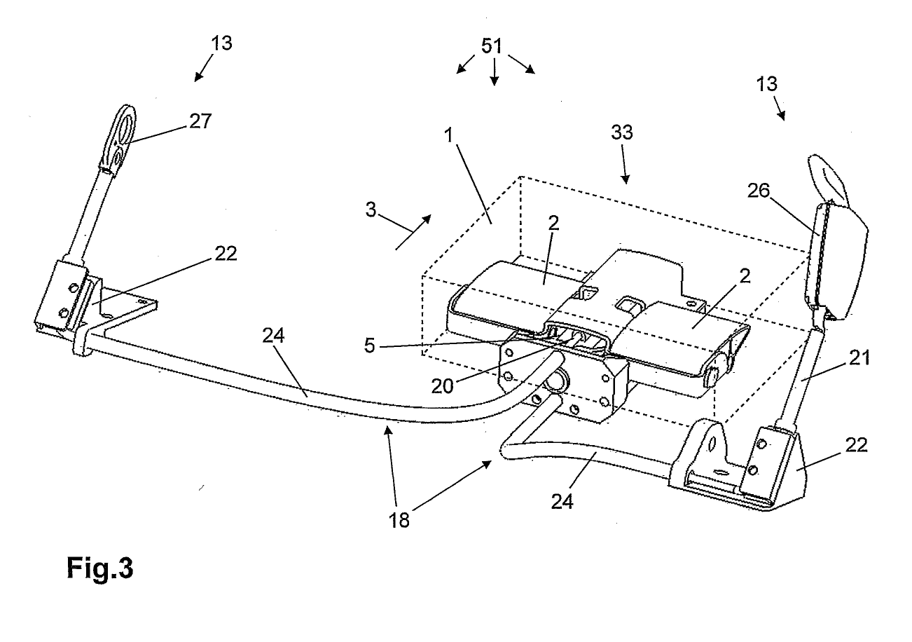

FIG. 3 shows a perspective view of the barrier system and restraint system,

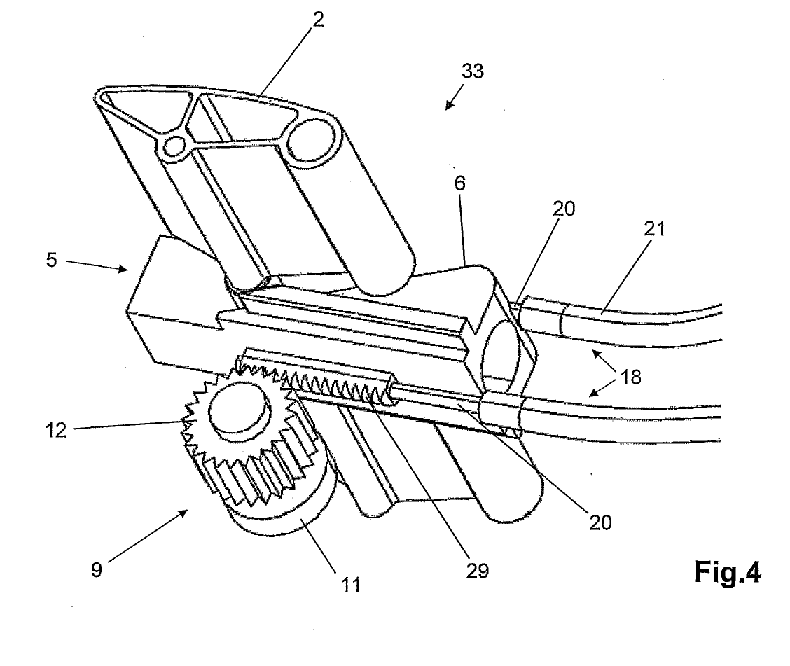

FIG. 4 shows a barrier system with a reversible drive means,

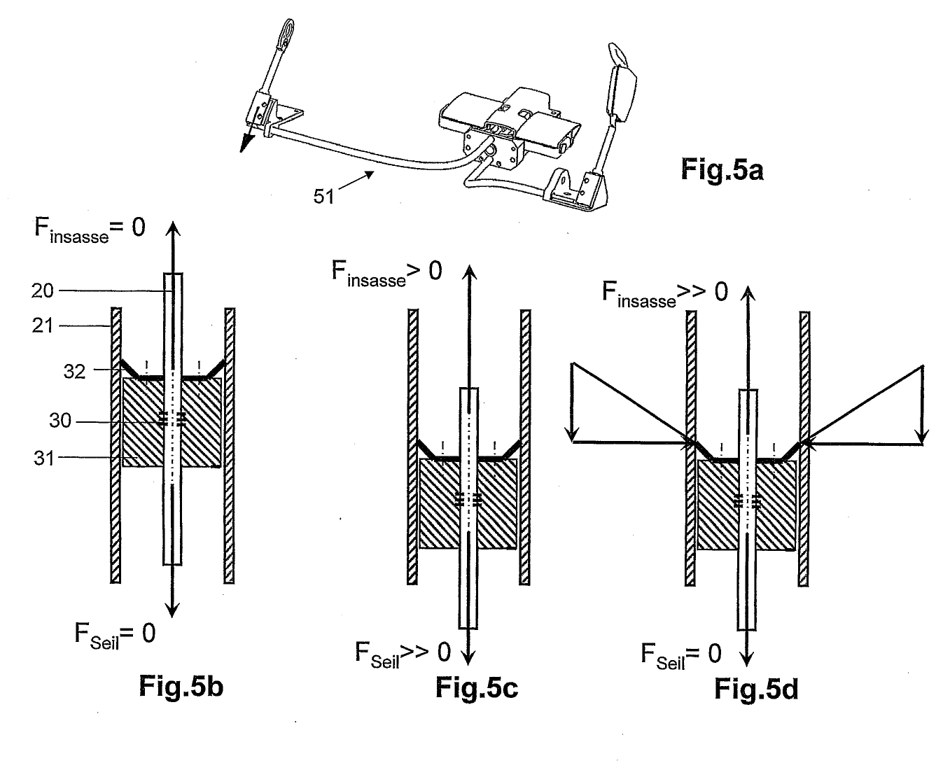

FIG. 5a shows a perspective view of a barrier system and a restraint system,

FIG. 5b shows a longitudinal section through a force transmitting means,

FIG. 5c shows a longitudinal section through a force transmitting means,

FIG. 5d shows a longitudinal section through a force transmitting means,

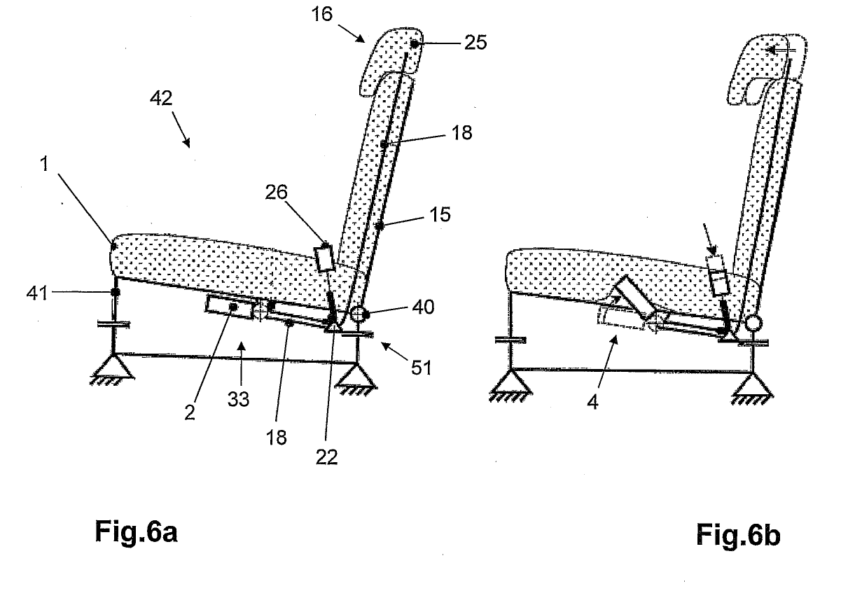

FIG. 6a shows a seat with a restraint system and neck support system,

FIG. 6b shows a seat with a restraint system and neck support system,

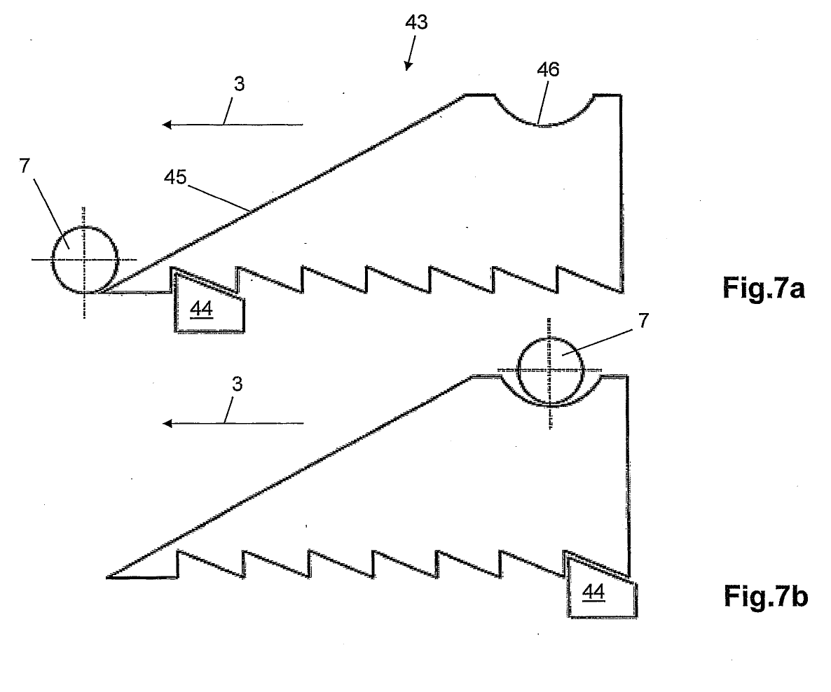

FIG. 7a shows a ramp means in the deactivated state,

FIG. 7b shows a ramp means in the activated state,

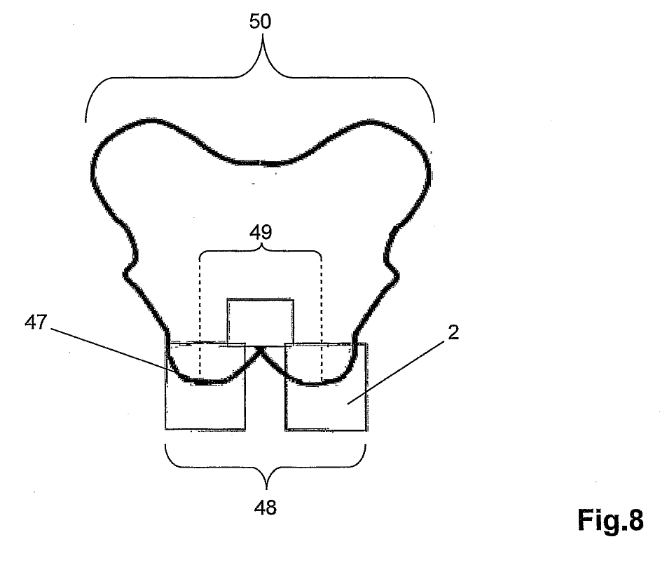

FIG. 8 shows a schematic illustration of a barrier means in front of a vehicle occupant's pelvis,

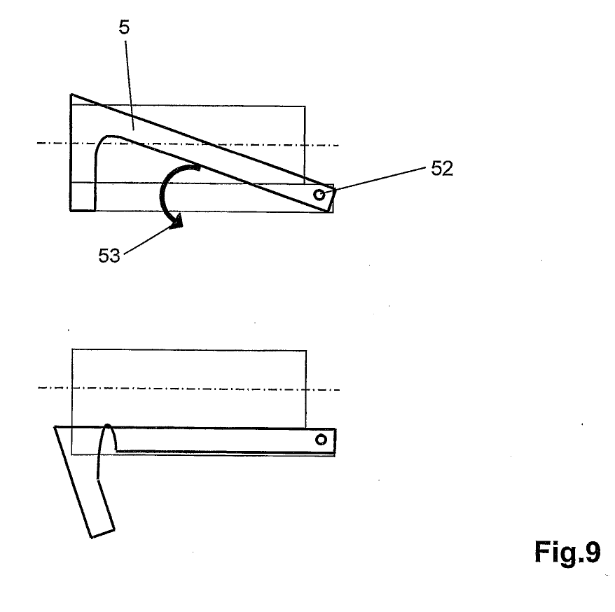

FIG. 9 shows a schematic illustration of the swiveling of a restraint means,

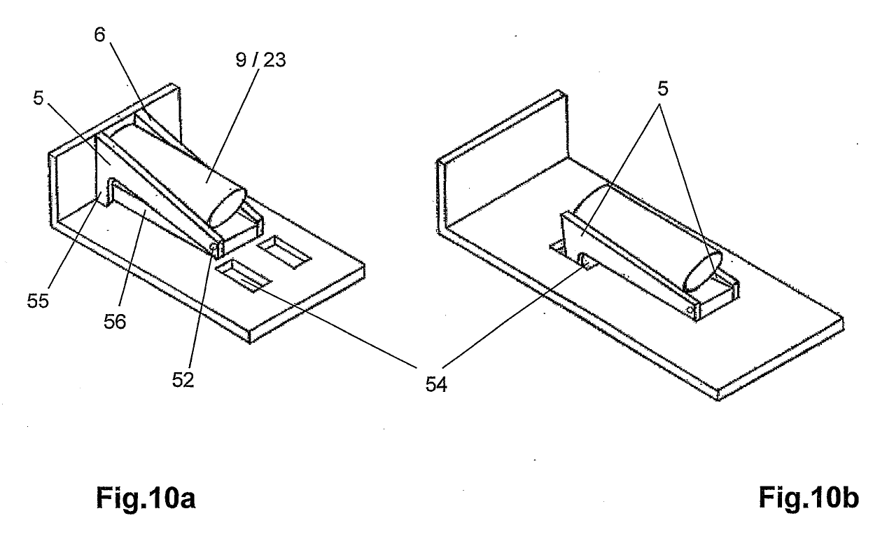

FIG. 10a shows a perspective illustration of a holding means before a swiveling process,

FIG. 10b shows a perspective illustration of a holding means after the swiveling process,

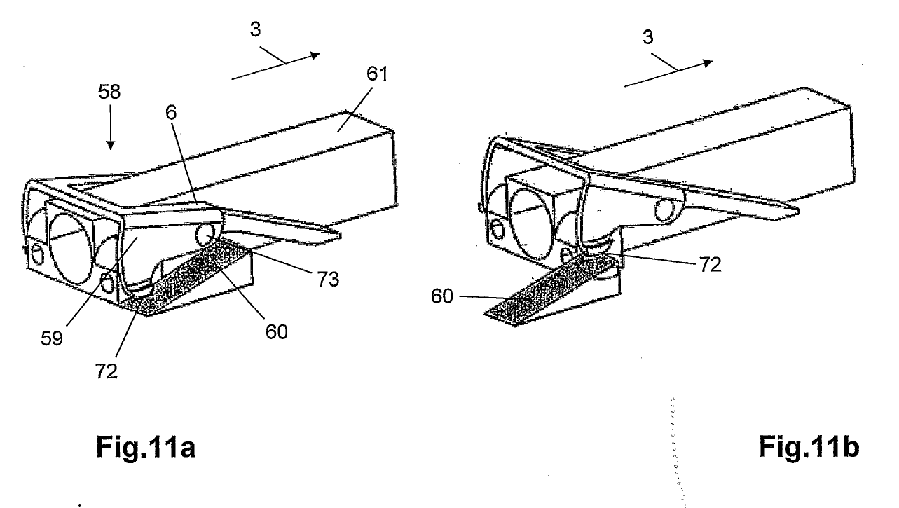

FIG. 11a shows a perspective illustration of a holding means having a wedge face which can fold down,

FIG. 11b shows a perspective illustration of a holding means having a wedge face which can fold down,

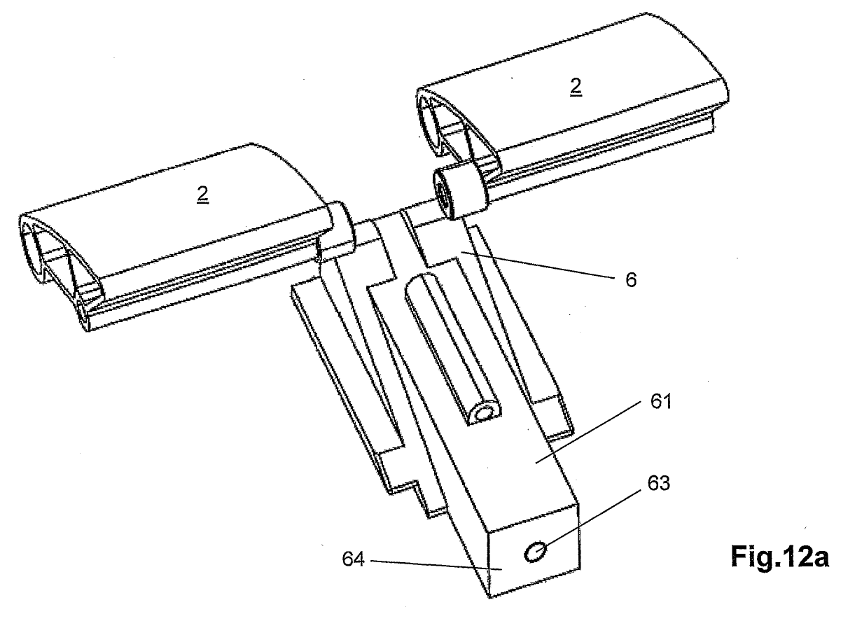

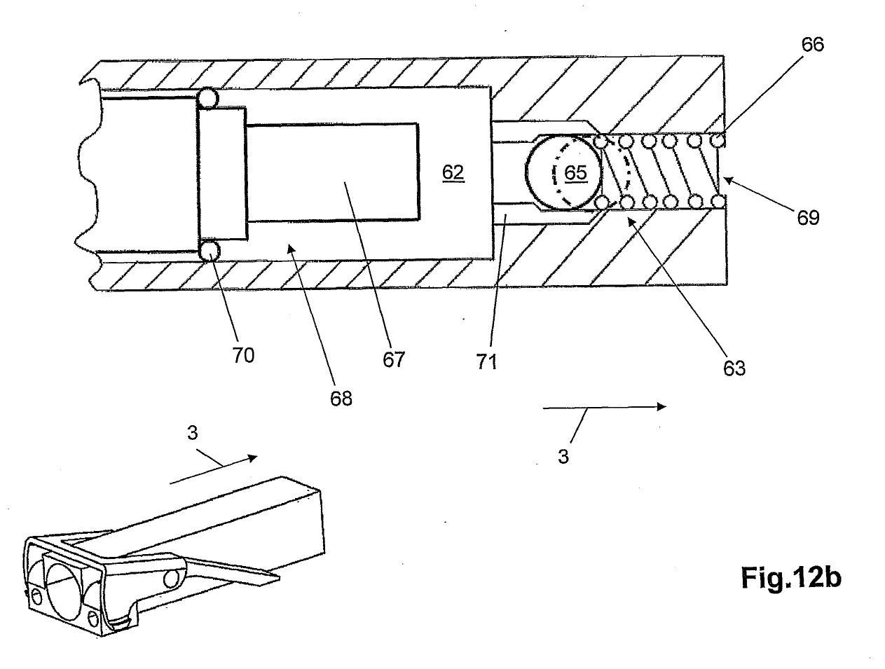

FIG. 12a shows a perspective illustration of a holding means having a valve which is arranged at the end, and

FIG. 12b shows an illustration of a longitudinal section with a valve.

FIG. 1 shows a barrier system 33 having a barrier means 2 and a self-locking means 5 in an exploded illustration. By way of example the barrier means 2 is constructed in two parts, with the two barrier center parts being arranged apart from one another at a distance which has a high probability of corresponding to the distance between the legs or to the pelvis arrangement of a vehicle occupant. In addition, the barrier center parts can easily be adapted in terms of size and construction, for example they can be wider, in order also to sufficiently support vehicle occupants who have a distance between their legs which deviates from the standard. An exemplary illustration of barrier means 2 with respect to the pelvis arrangement can be found in FIG. 8.

The barrier means 2 are held in a bearing sheath 34, 35 so as to be rotatable by means of a tilting axle 8. By means of contact elements 7 which are, for example, cylindrical and are attached in a rotatably fixed fashion to the barrier means 2, the barrier means 2 are in uninterrupted non-positively engaging contact or in frictional, non-positive and/or positive engagement with at least one wedge face 6 of the self-locking means 5. In the illustrated embodiment, a wedge face 6 is arranged on each side of the self-locking means 5 in order to permit the contact elements 7 to bear securely and transmit force.

In order to activate the effect of the self-locking means 5, the self-locking means 5 is displaced by a drive means in the direction of inertia 3 in which a vehicle occupant moves during a braking process of the vehicle. As a result, the wedge faces 6, which are arranged on the self-locking means 5 at an angle 19 which is open in the direction of inertia 3 and has a predetermined, adapted angle size, are pushed under the contact elements 7 of the barrier means 2 in such a way that the frictional engagement causes the contact elements 7 to rotate and therefore the barrier means 2 to tilt counter to the direction of inertia 3. In order to restrict the undesired movement of the vehicle occupant in the direction of inertia 3 as much as possible, the barrier means 2 may, for example, be actively activated, that is to say preventively when a possible accident is sensed, or else be placed in an upright position passively, i.e. immediately after the detection of an accident. As a result of the adapted angle size of the wedge faces 6, a strong restraining effect of the self-locking means 5 is maintained in this position, as is intended by the manufacturer. It is therefore not possible for an opposing force of the vehicle occupant, whether as a result of his weight or of further movements, to cause resetting of the barrier means 2 to occur, which would be disadvantageous for the vehicle occupant.

In the cited example, the drive means 23 exerts a linear thrust force on the self-locking means 5. The force is applied in the example by means of a pyrotechnic unit 10, in particular a micro gas generator, which permits a very fast drive. The drive means 23 is of irreversible design in the present example. The pyrotechnic unit 10, in particular a micro gas generator, is replaced by a new unit after a single activation. The drive means 23 is held in the end cover 36. The self-locking means 5 is arranged so as to be displaceable with respect thereto in the bearing sleeves 34, 35, with the result that activating the drive means allows the self-locking means 5 to be displaced under the contact elements 7 of the barrier means 2 which are mounted in a fixed but tiltable fashion in the bearing sleeves 34, 35. This displacement cannot be undesirably cancelled out again by the self-locking of the system. A secure hold of the tilted barrier means 2 is therefore made possible without further application of a holding force.

At the same time, attachment means 28 for force transmitting means 18, as illustrated, for example, in FIG. 4, are located on the self-locking means 5. The force which is exerted on the self-locking means 5 is therefore transmitted, for example, to the restraint system 13, as illustrated in FIG. 3. For this purpose, the force transmitting means 18 can be led out through, for example, lead-throughs 37 in the end cover 36.

FIG. 2a shows a barrier system 33 with barrier means 2 and a self-locking means 5 in the deactivated state. The contact elements 7 are allocated at a lower end 38 of the wedge faces 6.

FIG. 2b shows a barrier system 33 with barrier means 2 and a self-locking means 5 in the activated state. As a result of the displacement of the self-locking means 5 and as a result of the contact elements 7 which have rolled on the wedge faces 6 as far as an upper end 39, the barrier means 2 are now in an upright state 4 which permits them to be held counter to the direction of inertia 3.

FIG. 3 shows a perspective view of the barrier system 33 and restraint system 13. The barrier system 33 is arranged underneath a seat surface 1 in a region of a seat of a motor vehicle, as illustrated in FIGS. 6a-b. The barrier means 2 are in the inactivated state. The self-locking means 5 is arranged inside the bearing sleeves 34, 35 and is coupled by attachment means 28 to force means 18 which are led outward via the end cover 36 through lead-throughs 37. The force transmitting means 18 are connected to a restraint system 13. For this purpose, the force transmitting means 18 run from the barrier system to, in each case, a deflecting bracket 22 and through the latter to a seat belt lock 26 or to a seat belt end fitting 27. The force transmitting means 18 are composed, for example, of an inner cable means 20 and of a surrounding casing means 21. A loading on the cable means 20 of a force transmitting section 24 between the barrier system 33 and the deflecting bracket 22 can be relieved by passing on force from the cable means 20 into the casing means 21 in the region between the deflecting bracket 22 and the seat belt lock 26 or seat belt end fitting 27, as illustrated for example in FIGS. 5a-d.

FIG. 4 shows a barrier system 33 with an exemplary reversible drive means 9. For this purpose, a toothed rack 29, in which a gear wheel 12 of the drive means 9 runs, is arranged underneath the self-locking means 5. The drive energy is supplied by an energy accumulator, for example a torque accumulator 11, which is assigned to the gear wheel 12. The energy accumulator can be discharged by moving the gear wheel 12 forward, and can be reversibly recharged by turning the gear wheel 12 back. When a possible accident is sensed, the drive means 9 can be activated preventively, for example in the sense of an active system, and if a hazard situation then does not occur it can be deactivated without a unit having to be replaced. With the movement of the self-locking means 5 it is also possible, as illustrated by way of example, to activate two force means 18, composed of an inner cable means 20 and a surrounding casing means 21.

FIG. 5a shows a perspective view of the barrier system 33 and restraint system.

FIG. 5b shows a longitudinal section through a force transmitting means 18 having an internal cable means 20 and a surrounding casing means 21. The cable means 20 is surrounded by a guide means 31 and is connected thereto in an uninterrupted fashion via a connecting means 31. In the direction of the vehicle occupant, there is a locking means 31 which is directed counter to the direction of the vehicle occupant. The system is in a state of equilibrium in FIG. 5b. No force is exerted from the direction of the vehicle occupant and the cable means 20 is also relieved of loading.

FIG. 5c shows a different force distribution. A strong force is applied to the cable, and a force which is greater than zero acts on the vehicle occupant.

FIG. 5d shows a further force state in which the locking means 32 prevents a reaction on the stress of the cable means 20 as a result of the vehicle occupant pulling strongly on the force means. The force is instead diverted via the casing means 21. As a result, the cable means is relieved of loading in its further course.

FIG. 6a shows a seat 42 in a side view, having a seat frame 41 which holds a seat cushion with a seat surface 1. The seat cushion is adjoined by a seat backrest 15 having an articulation point 40 on the seat frame. A barrier system 33 having a self-locking means 5 is illustrated, in schematic fashion, inserted into the seat. Said self-locking means 5 is adjoined, connected via force transmitting means 18, by a restraint system 13 with a seat belt lock 26 or a seat belt end fitting and deflecting bracket 22. In addition, a neck support system 16 adjoins via a further force transmitting means 18. Activating the drive means and displacing the self-locking means also activates the neck support system 16. For example, a bolted connection is cancelled in this context and a neck support 25 is pushed forward in the direction of the vehicle occupant's neck, allowing whiplash to be prevented.

FIG. 6b shows a seat with a restraint system 13 and a neck support system 16 in the activated, upright state 4. In this context, on the one hand the barrier means 5 is tilted counter to the direction of inertia, and the restraint system is activated and retracted, and the neck support is displaced forward, with the result that the vehicle occupant is held in a very secure and stable fashion.

FIG. 7a shows a ramp means 43 in the deactivated state. The ramp means 43 has a ramp region 45 and a holding region 46, as well as a latching rail with a latching means 44 in the front position. A contact element 7 is illustrated schematically at the lower end of the ramp means 43.

FIG. 7b shows a ramp means in the activated state. The ramp means has been pushed forward in the direction of inertia 3 by a drive means (not illustrated), with the result that the latching means is latched in place in the last latching position, and the contact element has moved into the holding region 46, so that the barrier means 2 (not illustrated) are tilted counter to the direction of inertia. The ramp means 43 can replace the self-locking means in the preceding embodiments.

FIG. 8 shows a schematic illustration of barrier means 2 in front of a vehicle occupant's pelvis. The barrier means 2 are embodied in two parts and matched in their width 48 to the pelvis bones 47 of the vehicle occupant. In particular, the width 48 of the barrier means 2 is less than the width 50 of the pelvis, and in particular larger than a distance 49 between the pelvis bones 47. As a result, the transmission of force through the barrier means 2 is very locally limited and it is not necessary to tilt up any superfluous mass with the holding means, in particular the self-locking means.

FIG. 9 shows a schematic illustration of the swiveling of a holding means. The holding means is mounted so as to be capable of swiveling on a swivel axis 52 and can be swiveled in a swiveling direction 53, with the result that the holding means is reset from the upright position. As a result of this, the barrier means, which is not illustrated here, is also reset. This makes it possible to prevent the vehicle occupant from being displaced in a direction essentially perpendicular to the seat surface.

FIG. 10a shows a perspective illustration of a holding means before the swiveling, in particular of a self-locking means 5 with a wedge face 6. In this context, the driving drive means, which can be of reversible design 9 or irreversible design 23, is illustrated inside the holding means. A recess in the form of openings 54 into which supporting means 55, which correspond to the openings 54, of the holding means can be lowered when the holding means is lowered after a short time period after the placing in an upright position by means of a carriage 56, is illustrated in a surface of a housing 57, underneath the holding means. In the position in FIG. 10a, the openings 54 are still closed. After the carriage 56 has been moved back by the drive of the drive means 9, 23 in order to place the barrier means (not illustrated) in an upright position, the openings 54 are opened, with the result that the supporting means 55 of the holding means can be introduced after a certain time period, and the holding means is lowered.

FIG. 10b shows a perspective illustration of the holding means after the swiveling process. The supporting means 55 are lowered into the openings 54, and the holding means is moved out of its oblique position into a flat position, as a result of which the barrier means (not illustrated) is lowered again.

FIG. 11a shows a perspective illustration of a holding means having a wedge face 6 which can be folded down. The wedge face 6 is embodied in two parts and has a fixed lower region, and in the upper region 58 it has a moveable region 59 which is coupled thereto in an articulated fashion in a joint 73 and can be folded down. The region 59 is folded down toward the bottom in the illustration, as a result of which the overall height of the holding means is reduced. The region 59 which can be folded down can, as illustrated by way of example, be placed in an upright position by virtue of the fact that the region which can be folded down has a contact face 72 with which, when a load bearing means which has the wedge face 6 is displaced in the direction of inertia 3, it is pushed along a raising face 60 of a raising element as far as an end position.

FIG. 11a shows a perspective illustration of a holding means with a wedge face which can be folded down, wherein the end position of the process of placing the folded-down wedge face in an upright position has been reached. The wedge face 6 which can be folded down therefore permits a variable reduction in the overall height in the state of rest of the safety device. As a result, the safety device can, for example, also be used in seats with a small depth of the upholstery of the seat. In particular, by dividing the wedge face 6 into a fixed part and a moveable part, which is, in particular, mounted in such a way that it can swivel on the fixed part, on the one hand a high degree of stability of the device is ensured, and on the other hand the overall height is reduced in a variable fashion. The moving part of the wedge face 6 can be mounted here on the fixed part of the wedge face or else directly on the load bearing means 61. If the load bearing means 61 of the wedge face 6 is then moved in the direction of inertia 3 in order to position the barrier means 2 counter to the direction of inertia 3, the region 59, which can be folded down, of the wedge face 6 runs with a contact face and/or a contact point along the raising face 60, and said raising face 60 causes the region 59, which can be folded up, of the wedge face 6 to rotate upward in order to produce a uniform wedge face 6. The contact element 7 of the barrier means 2 then runs on this wedge face 6 counter to the direction of inertia 3, as shown by way of example in FIG. 2b.

FIG. 12a shows a perspective illustration of a holding means having a valve 63, arranged at its end on a head end 64, and having an opening 69.

FIG. 12b shows an illustration of a longitudinal section with the valve 63. A micro gas generator 67 is attached to a piston 69 which is introduced into a hollow pressure chamber 62 of the load bearing means 61. Through a circumferential seal 70, a pressure is built up after the micro gas generator 67 has been fired and there has been thrust in the direction of inertia 3. This pressure pushes the ball 65 of the valve 63 in the direction of the head end 64 of the load bearing means 61. As a result the ball 65 is counter to the spring force of the spring 66 to form a closure of an end-side opening 69. In the inactive position, the ball 65 permits, by displacement by means of the spring 66 in the direction of the pressure chamber 62 in the sense of a nonreturn valve, air to enter the pressure chamber 62 via the surrounding overflow means 71, and allows the micro gas generator to be easily reset into the initial position with the piston. The valve can be used easily, for example, in all illustrated variants of the holding means.

### LIST OF REFERENCE NUMERALS

1 Seat surface
2 Barrier means
3 Direction of inertia
4 Upright state
5 Self-locking means
6 Wedge face
7 Contact element
8 Tilting axle
9 Drive means, reversible
10 Pyrotechnic unit
11 Torque accumulator
12 Gear wheel
13 Restraint system
14 Seat belt pretensioner
15 Seat back rest
16 Neck support system
17 Direction
18 Force transmitting means
19 Angle
20 Cable means
21 Casing means
22 Deflecting bracket
23 Drive means, irreversible
24 Section of cable means
25 Neck support
26 Seat belt lock
27 Seat belt end fitting
28 Attachment means for the force transmitting means
29 Toothed rack
30 Connecting means
31 Guide means
32 Locking means
33 Barrier system
34 Bearing sleeve
35 Bearing sleeve
36 End cover
37 Lead-through
38 Lower end
39 Upper end
40 Articulation point
41 Seat frame
42 Seat
43 Ramp means
44 Latching means
45 Ramp region
46 Holding region
47 Pelvis bones
48 Width of the barrier means
49 Distance between pelvic bones
50 Width of pelvis
51 Safety device
52 Swiveling axis
53 Swiveling direction
54 Openings
55 Supporting means
56 Carriage
57 Housing
58 Upper region
59 Region which can be folded down
60 Raising face
61 Load bearing means
62 Pressure space
63 Valve
64 Head end
65 Ball
66 Spring
67 Micro gas generator
68 Piston
69 Opening
70 Seal
71 Overflow means
72 Contact face
73 Joint

1. A safety device for a seat for a vehicle, in particular a motor vehicle, having an at least partially flexible seat surface, having a barrier means which is to be arranged essentially under the seat surface and is to be placed in an upright position in order to prevent forward displacement of a vehicle occupant in the direction of inertia, in particular in the event of an accident, characterized in that the barrier means is held in the upright state by means of a holding means which is held, essentially without an additional force effect, to prevent a backward movement out of an end state of the holding means which corresponds to the upright state of the barrier means, wherein the holding means is, in particular, a self-locking means and/or a ramp means which can be latched in place, and wherein, after the barrier means has been placed in the upright position, the barrier means is to be reset, in particular by means of the holding means, after a time period which is sufficient to have restrained the vehicle occupant in order to prevent forward displacement.

2. (canceled)

3. The safety device according to claim 1, characterized in that in order to reset the barrier means the holding means is to be lowered at least partially into a recess which is arranged underneath the holding means and in particular is not to be opened until the holding means has been placed in an upright position.

4. The safety device according to claim 1, characterized in that the holding means is in particular held in a pivotable position on a foot and is to be pivoted down at least partially into the recess by means of a rotation about the pivoting axis.

5. The safety device according to claim 1, characterized in that the self-locking means has a wedge face with a predetermined angle and/or a wedge face with an at least partially concave and/or convex shape by means of which the barrier means can be placed in the upright position and/or the ramp means has a ramp region and a holding region and is to be held in the end state by means of a latching means.

6. The safety device according to claim 5, characterized in that the wedge face of the self-locking means is designed in such a way that it can be at least partially folded down.

7. The safety device according to claim 5, characterized in that the wedge face can be folded down in the upper region (58).

8. The safety device according to claim 5, characterized in that in the folded down region the wedge face can be folded up essentially as far as an end state, essentially before and/or during the placing of the barrier means in an upright position against the wedge face, said folding up being carried out in particular by means of a raising means, in particular by displacement of the wedge face in relation to a raising face.

9. The safety device according to claim 5, characterized in that the barrier means engages with the wedge face of the self-locking means in a frictionally locking and/or positively locking fashion and/or is held in the holding region of the ramp means by means of at least one contact element by means of which the barrier means is to be folded up.

10. The safety device according to claim 5, characterized in that the self-locking means is to be activated by displacing the wedge face of the self-locking means, in particular by means of linear displacement in the direction of inertia and/or the ramp means is to be activated by means of displacement, in particular linear displacement, the ramp region until an end position of the contact element in the holding region is reached.

11. The safety device according to claim 5, characterized in that the wedge face and/or the ramp region are/is to be displaced by at least one actuating means, which is fast compared to the speed of forward displacement of the vehicle occupant, by exerting a thrust force and/or tractive force.

12. The safety device as according to claim 1, characterized in that the barrier means is embodied in two parts and is arranged on each side of the holding means, in particular of the self-locking means (5) and/or of the ramp means, wherein a width of the barrier means is, in particular, less than the width of the pelvis and in particular greater than a distance between the pelvic bones.

13. The safety device as according to claim 11, characterized in that one actuating means is of reversible design and/or one actuating means is of irreversible design.

14. The safety device according to claim 11, characterized in that the irreversible type actuating means comprises a pyrotechnic unit and/or a unit with gas triggering, in particular a micro gas generator.

15. The safety device according to claim 11, characterized in that the irreversible type actuating means comprises a gear wheel which is driven by an energy accumulator, in particular a torque accumulator, in particular a helical spring.

16-36. (canceled)

37. The safety device according to claim 1, characterized in that a change in pressure is to be brought about in a pressure space inside a load bearing means for the wedge face by activating a actuating means in order to displace the load bearing means, in particular by means of a reversible drive, in particular with an energy accumulator, in particular with a gear wheel which is driven by a torque accumulator, wherein the pressure space is to be ventilated to bring about pressure equalization by means of a valve, in particular a nonreturn valve with a ball on which a spring acts.

38. The safety device according to claim 1, characterized in that a unit with gas triggering, in particular a micro gas generator, is provided as the actuating means, and a reversible actuator, in particular with an energy accumulator, in particular with a gear wheel which is driven by a torque accumulator, with the result that at first the barrier means can be positioned by the gear wheel drive in a slow, cautious fashion, wherein the valve ventilates the pressure space in order to bring about pressure equalization, and then, in particular if an accident is actually detected in the same time period, the unit with gas triggering is to be additionally fired, with the result that the positioning of the barrier means is to be accelerated, wherein the pressure space which is activated by the unit with gas triggering is closed off, in order to bring about a rapid increase in pressure by the valve, in particular by the nonreturn valve with a ball on which a spring acts.

39. The safety device according to claim 1, characterized in that the valve is arranged at a head end of the pressure space.

40. The safety device according to claim 1, characterized in that in an active position the valve closes off the pressure space, and in an inactive position it permits air to pass through.

41. The safety device according to claim 1, characterized in that the valve has a spring-loaded ball which, when there is an increase in pressure, closes off the pressure space, and, when there is a decrease in pressure, is placed, by means of the spring, in the position which permits air to pass through.

42. A safety device for a seat for a vehicle, in particular a motor vehicle, having an at least partially flexible seat surface, having a barrier means which is to be arranged essentially under the seat surface and is to be placed in an upright position in order to prevent forward displacement of a vehicle occupant in the direction of inertia, in particular in the event of an accident, characterized in that the barrier means is to be activated essentially simultaneously with activation of a restraint system, in particular a seat belt pretensioner in a seat belt lock and/or a seat belt end fitting, in particular on the seat backrest, and/or essentially simultaneously with activation of a neck support system, wherein in particular the activation of the neck support system is to be performed by releasing a neck support in the direction of the vehicle occupant's neck.

43. The safety device according to claim 42, characterized in that the restraint system and/or the neck support system are/is connected to the holding means, in particular the self-locking means, via, in particular, at least one respectively separate force transmitting means, wherein when the holding means, in particular the self-locking means, is activated, force is simultaneously also to be applied to the restraint system and/or the neck support system.

44. The safety device according to claim 43, characterized in that in each case a force transmitting means in the form of at least one encased cable means is arranged in the restraint system in such a way that it runs from the holding means, in particular the self-locking means, to the seat belt lock or seat belt end fitting via a deflecting bracket, wherein tensile forces have to be diverted from the cable means (20) to the casing means which is arranged around the cable means and is supported on the deflecting seat belt, with the result that at least one cable means section is held essentially free of force between the holding means, in particular the self-locking means, and the deflecting bracket.

45. The safety device according to claim 44, characterized in that an actuating means is integrated with the holding means, in particular the self-locking means.

46. A safety device for a seat for a vehicle, in particular a motor vehicle, having an at least partially flexible seat surface, having a barrier means which is to be arranged essentially under the seat surface and is to be placed in an upright position in order to prevent forward displacement of a vehicle occupant in the direction of inertia, in particular in the event of an accident, characterized in that the barrier means is equipped with a warning function, in particular in the event of the vehicle leaving the lane, wherein the warning function is embodied, in particular, as a vibrator system which is installed, in particular, on the contact element in order to move the barrier means.
